(19) United States
(12) Patent Application Publication
(10) Pub. No.: US 2019/0174916 A1
(43) Pub. Date: Jun. 13, 2019

(54) SHELF DIVIDER

(71) Applicant: International Sales Inc., Virginia Beach, VA (US)

(72) Inventor: Thomas G.B. MEREY, Ontario (CA)

(21) Appl. No.: 16/170,714

(22) Filed: Oct. 25, 2018

(30) Foreign Application Priority Data
Dec. 8, 2017 (CA) 2 988 400

(51) Int. Cl. A47B 57/58; F16B 2/12

(52) U.S. Cl. CPC A47B 57/58; F16B 2/12

(57) ABSTRACT

The shelf divider has a panel for separating objects on a shelf and a clamp for attaching the panel to a shelf. The lower jaw of the clamp contacts the lower wall of the shelf while the upper jaw contacts the upper wall. A row of teeth is provided on the outer edge of the panel and slides in an upwardly extending groove in the lower jaw. A detent is formed in the groove and is normally out of engagement with the teeth until an upward force is applied to the lower jaw for causing pivotal movement of the row of teeth about the upper jaw with resulting engagement of the detent with the teeth and simultaneous locking of the clamp to the shelf.

### FIELD OF THE INVENTION

This invention relates to an organizer for objects on a shelf and more particularly to a shelf divider which can be place on a shelf wherever objects can be arranged most conveniently on the shelf.

### CROSS-REFERENCE TO RELATED PRIOR APPLICATION

This application claims priority pursuant to 35 USC 119 of Canadian application no. 2,988,400 filed Dec. 8, 2017 in the Canadian Intellectual Property Office which application is incorporated herein by reference.

### BACKGROUND OF THE INVENTION

Objects on a shelf normally relate to various subject matter and it is useful to be able to arrange the objects so that those relating to the same subject matter are located together and those relating to different subject matter are located elsewhere. Dividers consisting of upright panels of wood or plastic are commonly used for this purpose but they often lack the flexibility necessary to be very useful. Some are permanently attached to a shelf so that they cannot be moved to a location where objects on the shelf can be arranged more conveniently. The location of others while movable is often restricted to fixed locations and those locations may not be very convenient.

### SUMMARY OF THE INVENTION

I have invented a divider which can be located anywhere on a flat shelf. The divider can be attached to a shelf having any thickness within a given range and can be attached and detached quickly without any tools. The divider of my invention includes: a panel for separating objects on the shelf. The panel is attached to the shelf by means of a clamp and is provided with upper and lower jaws, the upper jaw being adapted to rest on top of the shelf while the lower jaw being disposed beneath the shelf. The lower jaw is provided with horizontal and vertical segments. The horizontal segment has inner and outer sections, the inner section being sloped downward toward the outer section and being adapted to contact the shelf while the outer section is disposed below and out of contact with the shelf and pivots upward about the upper jaw when a force is applied to it. The lower jaw is provided with a vertical segment having an upwardly extending groove. A row of teeth is movable upwardly and downwardly in the groove. Movement of the teeth causes the space between the upper and lower jaws of the clamp to increase and decrease. A detent is provided which is normally out of engagement with the row of teeth until an upward force is applied to the outer section of the lower jaw. The force causes upward movement of the outer section and resulting pivotal movement of the detent toward and into engagement with the row of teeth and resulting locking of the clamp to the shelf.

### DESCRIPTION OF THE DRAWINGS

The adjustable divider of my invention is described below in conjunction with the ac-companying drawings in which:

FIG. 1 is a perspective view of the shelf divider;

FIG. 2 is a perspective view of the divider in conjunction with a pair of shelves spaced vertically apart;

FIG. 3 is a perspective view of a vertical segment of a lower jaw of a clamp and a row of teeth adapted to slide in a groove in the jaw;

FIG. 4 is an elevation of a the clamp and a portion of a shelf;

FIG. 5 is another elevation of the clamp in an inoperative position detached from a shelf;

FIG. 6 is an elevation of the clamp in an operative position;

FIG. 7 is an elevation of the clamp in the process of being disengaged from a shelf; and

FIG. 8 is an elevation of the clamp fully disengaged from a shelf.

Like reference characters refer to like parts throughout the description of the drawings.

### DESCRIPTION OF PREFERRED EMBODIMENTS

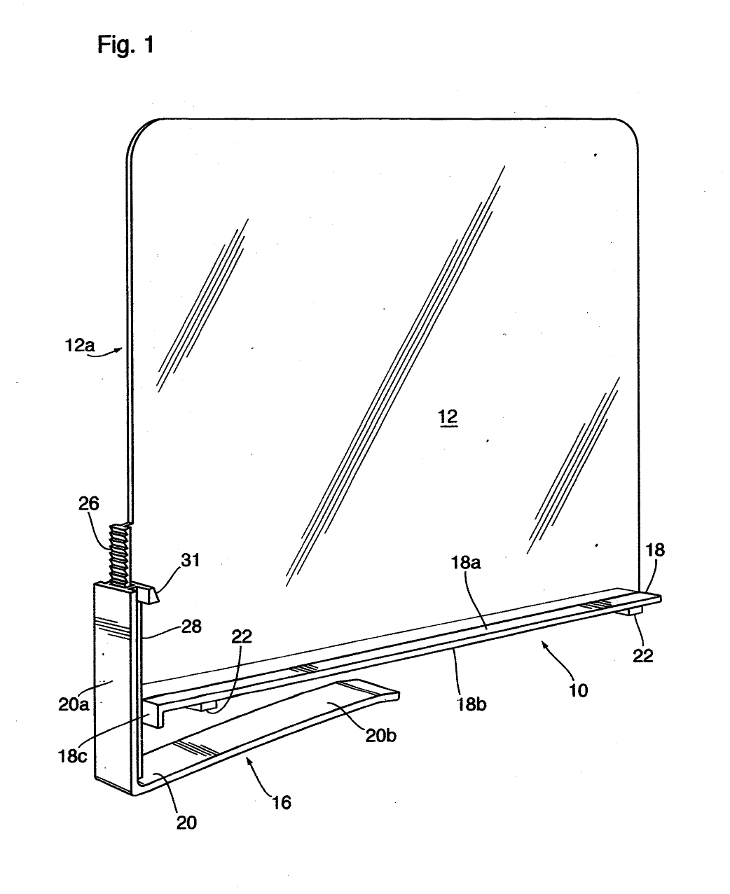

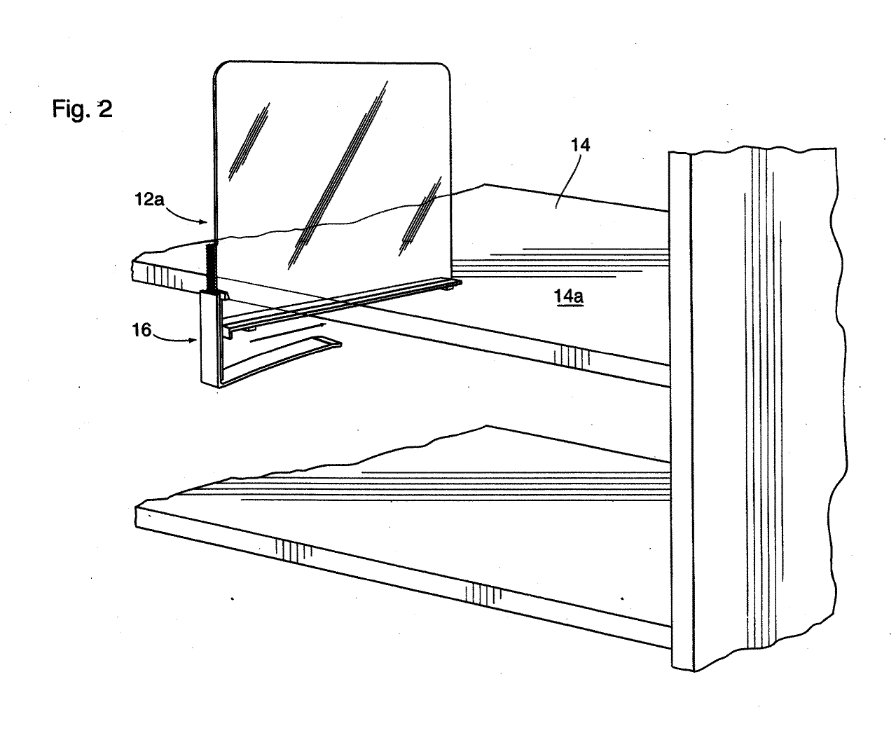

With reference to FIGS. 1 and 2, the adjustable shelf divider of the invention, generally 10, is composed of an upstanding panel 12 for separating objects on a shelf 14. At the outer edge of the panel, generally 12a the shelf divider is provided with a clamp, generally 16 for attaching the shelf divider to the shelf.

The clamp is comprised of upper and lower jaws 18, 20 respectively. Panel 12 is seated on the upper wall 18a of the upper jaw while on the lower wall 18b of the jaw a pair of pads composed of soft material is provided for protecting the upper surface 14a of the shelf on which the jaw is seated. The outer end of the jaw is bent downward at 18c and serves as fulcrum for the lower jaw 20, described below.

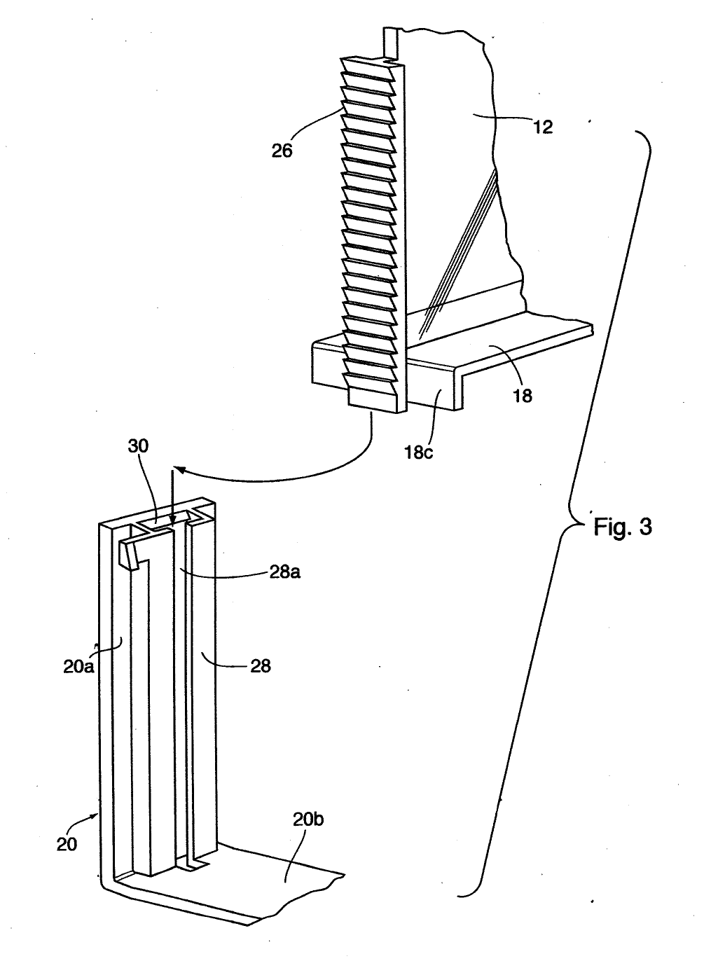

With reference to FIGS. 1 and 3, the lower jaw 20 is composed of two segments, an upwardly extending so-called vertical segment 20a and a laterally extending so-called horizontal segment 20b. The terms vertical and horizontal in this context are intended to indicate how these components of the lower jaw are oriented when the clamp is in normal use however should the shelf be tilted out of a horizontal position, these components will obviously not be oriented horizontally and vertically.

A raised wall 28 is formed on the vertical segment in which a groove 28a is formed. The groove serves as a passageway for a row of teeth 26 which is formed on the outer edge of panel 12. The teeth are free to slide upwardly and downwardly in the groove unless they engage with a detent 30 on the inside wall of the groove. The detent functions to immobilize the teeth in the groove.

A stop 31 is provided at the upper end of the vertical segment of the lower jaw. The stop engages with the upper jaw for preventing the lower jaw from separating from the upper jaw.

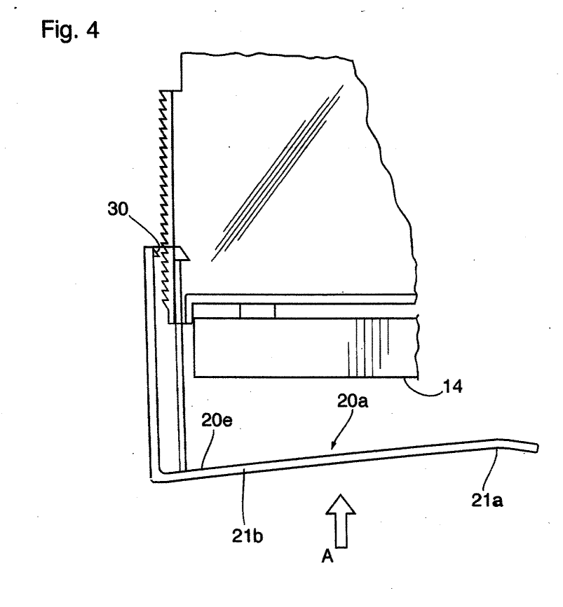

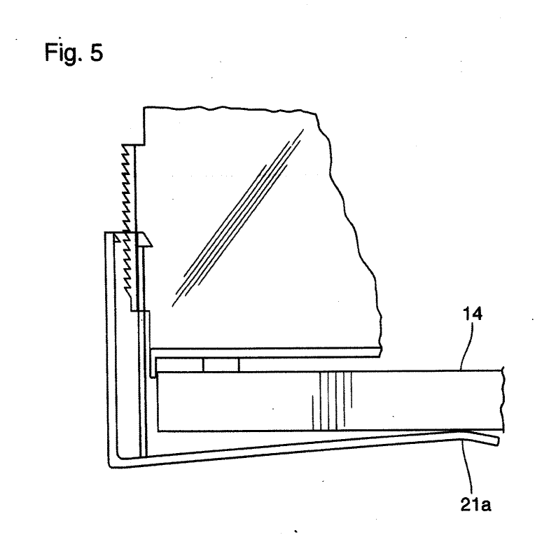

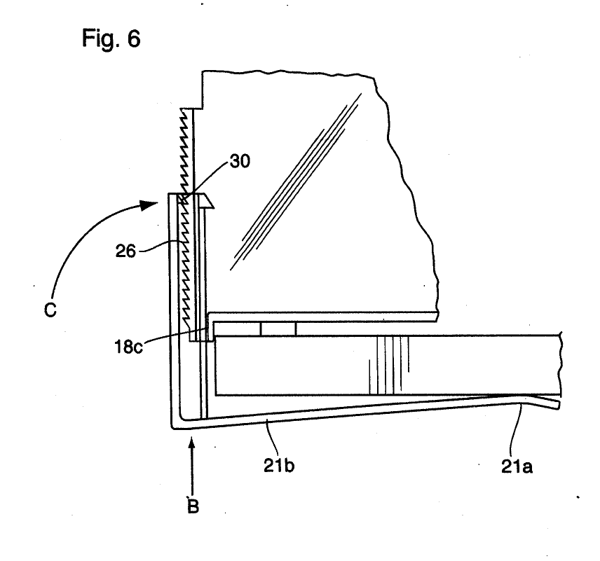

With reference to FIGS. 4 to 6, the horizontal segment 20a of the lower jaw has inward and outward sections 21a, 21b, respectively. The inner section 21a is adapted to contact the shelf as illustrated in FIGS. 5 and 6 whereas the outer section does not, being prevented from doing so by the inner section. The outer section is accordingly below and out of contact with the shelf.

Operation of the Shelf Divider

The operation of the adjustable divider is illustrated in FIGS. 3 to 7. With reference first to FIG. 3, the two jaws are interconnected by inserting the row of teeth into the upper opening of the groove as indicated by the arrows and lowering the row of teeth in the groove. Next, the shelf divider is positioned adjacent to the outer edge of a shelf 14 as illustrated in FIG. 4 and the lower jaw is pushed by hand upward in the direction of the arrow A until the inner section 21a contacts the lower surface of the shelf as illustrated in FIG. 5.

The outer section 21b of the lower jaw is then pushed further upwardly in the direction of arrow B in FIG. 6. As the vertical section rises the lower jaw being flexible pivots clockwise about fulcrum 18c of the upper jaw. The pivotal movement is in the direction of arrow C and as the jaw pivots, detent 30 moves into engagement with the teeth 26 as illustrated in FIG. 6 and remains in engagement or is locked there because of friction and the downward pressure exerted by the detent on the teeth caused by the downward resilient bias of the lower jaw. The shelf divider is then firmly clamped to the shelf by virtue of the pressure on the shelf by the upper and lower jaws of the clamp.

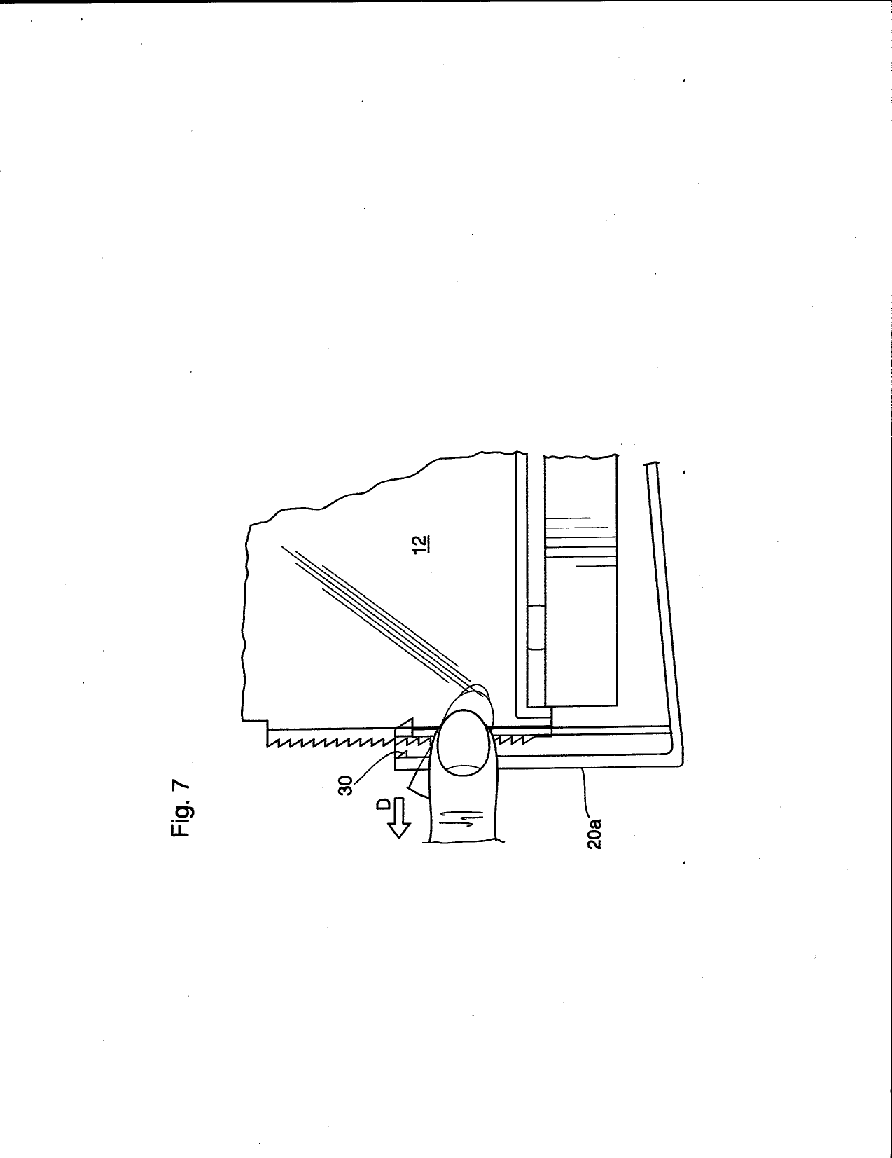

With reference to FIG. 7, the adjustable shelf divider is removed from the shelf by grasping the vertical segment 20a of the lower jaw by pinching it. The vertical segment is then pulled outward and away in the direction of arrow D. The lower jaw being flexible yields to the pull and allows the detent to withdraw from engagement with the teeth. The vertical segment can then be separated from the teeth and lowered relative to the teeth to relieve the pressure on the shelf by the lower jaw. The shelf divider can then be removed from the shelf.

It should be noted that once the detent is engaged to the teeth, the bias of the lower jaw causes the detent to remain in engagement. It is only when an outward force is applied to the vertical segment of the lower jaw opposed to the bias that the detent will separate from the teeth. That force is applied in the direction of arrow D in FIG. 7.

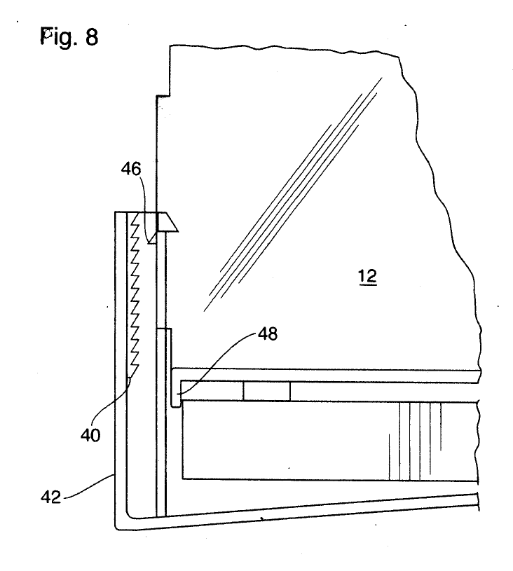

The position of the detent and the row of teeth can be reversed from that in the previous figures as illustrated in FIG. 8. As illustrated, the teeth 40 are located in the groove in the vertical segment 42 of the lower jaw while detent 46 is formed in the outer edge of panel 12. In that Figure, the teeth have been separated from the detent by pulling the outer vertical segment outward in the manner described above with reference to FIG. 7 so that the lower jaw can be separated from the shelf.

It will be understood, of course, that modifications can be made in the adjustable shelf divider of the invention without departing from the scope and purview of the invention as set out in the attached claims.

1. An adjustable shelf divider adapted to be selectively attached to and detached from a shelf, said shelf divider including: a panel for separating objects on the shelf; a clamp supporting said panel and being provided with upper and lower jaws for selectively engaging oppositely facing upper and lower walls, respectively, of the shelf; a row of teeth immovable relative to one said jaw; a detent associated with the other said jaw and pivotal into and out of engagement of said row of teeth for alternatively preventing and allowing, respectively, movement of said one jaw relative to said other jaw with resulting locking and unlocking, respectively, of said clamp to the shelf.

2. The adjustable shelf divider of claim 1 wherein said row of teeth is provided on an outer edge of said panel.

3. The adjustable shelf divider of claim 1 wherein said row of teeth is provided on an outer edge of said panel and slides in an upwardly extending groove in said lower jaw, and wherein said detent is formed in said groove and is normally out of engagement with said row of teeth until an upward force is applied to said lower jaw for causing pivotal movement of said row of teeth about said upper jaw with resulting engagement of said detent with said row of teeth.

4. An adjustable shelf divider adapted to be selectively attached to and detached from a shelf, said shelf divider including: a panel for separating objects on the shelf; a clamp supporting said panel and being provided with upper and lower jaws for selectively engaging oppositely facing upper and lower walls, respectively, of the shelf; a detent immovable relative to one said jaw; a row of teeth associated with the other said jaw and pivotal into and out of engagement with said detent for alternatively preventing and allowing, respectively, movement of said one jaw relative to said other jaw with resulting locking and unlocking, respectively, of said clamp to the shelf.

5. An adjustable shelf divider adapted to be selectively attached to a shelf, said adjustable
shelf divider including: a panel for separating objects on the shelf; a clamp supporting said panel and being provided with upper and lower jaws for selectively engaging the shelf between said jaws, said lower jaw having generally horizontal and vertical segments, said horizontal segment being adapted to extend beneath the shelf and having inner and outer sections, said inner section being adapted to engage the shelf while said outer section is out of contact with the shelf and is resiliently bendable upwardly when said inner section is engaged with the shelf with resulting pivotal movement of said vertical segment about said upper jaw, an upwardly extending row of teeth; and a detent, either one of said row of teeth and said detent being immovable relative to said upper jaw while the other one of said row of teeth and said detent being immovable relative to said vertical segment, said detent being out of engagement with said row of teeth until an upward force is applied to said outer section for causing pivotal movement of said vertical segment about said upper jaw with resulting engagement of said detent with said row of teeth and simultaneous locking of said clamp to the shelf.

6. The adjustable shelf divider of claim 5 wherein said row of teeth is provided on an outer edge of said panel and said detent is provided on a wall of said groove.

7. The adjustable shelf divider of claim 5 wherein said vertical segment is provided with an elongated groove within which said row of teeth is immovably disposed and said detent is formed on an outer edge of said panel.

8. The adjustable shelf divider of claim 5 wherein said, vertical segment is arranged and constructed such that when said detent is engaged with said row of teeth, said detent remains in engagement until a force, opposed to the resilient bias of said outer section of said lower jaw is applied to said vertical segment for causing said detent to separate from said row of teeth.

9. An adjustable shelf divider adapted bo be selectively attached to a shelf, said shelf divider including: a clamp provided with upper and lower jaws, said upper jaw being disposed above the shelf, said lower jaw being provided with a resilient horizontal segment adapted to extend beneath the shelf and being sloped downward from an inner section to an outer section, said inner section being adapted to contact the shelf while said outer section is out of contact with the shelf, said
outer section being bendable upwardly when a force is applied thereto with resulting resilient deformation of said outer section, said lower jaw having a vertical segment which extends upwardly from said outer section and which is provided with an upwardly extending groove; a panel for separating objects on the shelf and being supported by said upper jaw, said panel having an upwardly extending row of teeth slidingly received in said groove for upward and downward movement relative to said lower jaw with resulting increase and decrease in the space between said upper and lower jaws, a detent formed in said groove and out of engagement with said row of teeth until said upward force is applied to said outer section with resulting pivotal movement of said vertical segment and simultaneous movement of said detent toward and into engagement with said row of teeth with resulting locking of said clamp to the shelf.

10. The adjustable shelf divider of claim 9 wherein said row of teeth is provided on an outer edge of said panel.

11. The adjustable shelf divider of claim 9 wherein said row of teeth is provided on an outer edge of said panel and slides in an upwardly extending groove in said lower jaw, and wherein said detent is formed in said groove and is normally out of engagement with said row of teeth until an upward force is applied to said lower jaw for causing pivotal movement of said row of teeth about said upper jaw with resulting engagement of said detent with said row of teeth.
